(19) United States
(12) Patent Application Publication
(10) Pub. No.: US 2015/0367577 A1
(43) Pub. Date: Dec. 24, 2015

(54) USE OF MULTIPLE BEAM SPOT SIZES FOR OBTAINING IMPROVED PERFORMANCE IN OPTICAL ADDITIVE MANUFACTURING TECHNIQUES

(71) Applicant: Materialise N.V., Leuven (BE)

(72) Inventor: Sam COECK, Boutersem (BE)

(21) Appl. No.: 14/309,788

(22) Filed: Jun. 19, 2014

(51) Int. Cl. B29C 67/00; G05B 15/02

(52) U.S. Cl. CPC B29C 67/0088; B29C 67/0066; G05B 15/02; B33Y 10/00

(57) ABSTRACT

Methods and apparatuses for using multiple beam spot widths in order to obtain improved performance in optical additive manufacturing techniques are disclosed. In some embodiments, an optical additive manufacturing apparatus for manufacturing an object, comprises a scanner configured to direct a beam emitted by an emitter towards an object layer and a control module in data communication with the scanner. The control module may be configured to: calculate a plurality of hatch vectors; select two or more of the plurality hatch vectors to be compared; compare the two or more selected hatch vectors to a first combination parameter; and calculate a first new hatch vector based on the two or more selected hatch vectors.

### BACKGROUND OF THE INVENTION

Methods of additive manufacturing may use a radiant emitter to emit a beam that processes an underlying material. Optical elements may be used to affect the size of the beam or resulting beam spot on the underlying material.

Using a beam with a larger beam spot size to process underlying material may offer several advantages. For example, a larger beam spot may reduce the total number of vectors that the beam spot needs to traverse in order to process a particular area, which, in-turn, may reduce the total processing time of an object. This strategy may be particularly useful when processing an infill area i.e. an area within the outer contours of an object being manufactured.

A disadvantage to using a larger beam spot size is the inability to process features that are smaller than the beam spot size. Thus, there is a tradeoff between beam spot size and processing speed and resolution, which may ultimately affect manufacturing speed and quality of the object as a whole.

Accordingly, there is a need for apparatuses and methods for utilizing various beam spot sizes to increase the speed of optical additive manufacturing while maintaining the ability to form small features.

### SUMMARY

This application describes methods and apparatuses for using multiple beam spot sizes in order to obtain improved performance in optical additive manufacturing techniques.

In one embodiment, an optical additive manufacturing apparatus for manufacturing an object, comprises: a scanner configured to direct a beam emitted by an emitter towards an object layer; a control module in data communication with the scanner, wherein the control module is configured to: calculate a plurality of hatch vectors; select two or more of the plurality hatch vectors to be compared; compare the two or more selected hatch vectors to a first combination parameter; and calculate a first new hatch vector based on the two or more selected hatch vectors.

In some embodiments of the optical additive manufacturing apparatus, the emitter is a laser emitter and the beam is a laser beam.

In some embodiments of the optical additive manufacturing apparatus, the first combination parameter relates to a proximity of a first endpoint of a first selected hatch vector and a first endpoint of a second selected hatch vector.

In some embodiments of the optical additive manufacturing apparatus, the first combination parameter relates to a length of a first selected hatch vector.

In some embodiments of the optical additive manufacturing apparatus, the control module is further configured to: compare the two or more elected hatch vectors to a second combination parameter.

In some embodiments of the optical additive manufacturing apparatus, the second combination parameter is different than the first combination parameter.

In some embodiments of the optical additive manufacturing apparatus, the control module is further configured to: calculate the first new hatch vector based on a first beam size.

In some embodiments of the optical additive manufacturing apparatus, the control module is further configured to: calculate a second new hatch vector based on a second beam size.

In some embodiments of the optical additive manufacturing apparatus, the control module is further configured to: calculate an adjusted object layer offset based on the calculated first new hatch vector.

In some embodiments of the optical additive manufacturing apparatus, the scanner further comprises: a sensor.

In another embodiment, a method of determining a plurality of hatch vectors, comprises: calculating a plurality of hatch vectors; selecting two or more of the plurality hatch vectors to be compared; comparing the two or more selected hatch vectors to a first combination parameter; calculating a first new hatch vector based on the two or more selected hatch vectors; and directing, using a scanner, a beam emitted by an emitter along the new hatch vector.

In some embodiments of the method, the emitter is a laser emitter and the beam is a laser beam.

In some embodiments of the method, the first combination parameter relates to a proximity of a first endpoint of a first selected hatch vector and a first endpoint of a second selected hatch vector.

In some embodiments of the method, the first combination parameter relates to a length of a first selected hatch vector.

In some embodiments of the method, the method further comprises: comparing the two or more elected hatch vectors to a second combination parameter.

In some embodiments of the method, the second combination parameter is different than the first combination parameter.

In some embodiments of the method, the control module is further configured to: calculate the first new hatch vector based on a first beam size.

In some embodiments of the method, the method further comprises: calculating a second new hatch vector based on a second beam size.

In some embodiments of the method, the method further comprises: calculating an adjusted object layer offset based on the calculated first new hatch vector.

In some embodiments of the method, the scanner comprises a sensor.

### BRIEF DESCRIPTION OF THE DRAWINGS

FIG. 1 depicts an example of an optical additive manufacturing apparatus according to one or more embodiments disclosed herein.

FIG. 2A shows an example of an object layer demonstrating various problems that may arise given the selection of a particular beam characteristic, such as beam spot width.

FIG. 2B depicts yet another problem when choosing a particular beam characteristic, such as beam spot width.

FIG. 3 depicts an exemplary method for improving hatch vector calculation using multiple beam spot sizes.

FIGS. 4A-4C depict examples of the results of a hatch vector optimization method.

FIG. 5 depicts another possible method for optimizing hatch vectors in an object layer.

FIG. 6 depicts an exemplary system for designing and manufacturing an object by additive manufacturing

FIG. 7 depicts a functional block diagram of one example of a computer of FIG. 6.

FIG. 8 depicts a process for manufacturing a 3D object.

### DETAILED DESCRIPTION OF CERTAIN INVENTIVE EMBODIMENTS

The present application discloses apparatuses and methods for using multiple beam spot sizes for obtaining improved performance in optical additive manufacturing techniques.

Methods of additive manufacturing may include the use of radiant emitters, such as lasers or other high-intensity light sources, for fusing, sintering, melting, curing or otherwise processing a base material in order to create three-dimensional objects.

A radiant emitter's beam, such as a laser beam, may be controlled by a scanner, which directs the beam along a particular path in order to process an underlying material and form an object. The scanner may be used to form, for example, an “outline” or “boundary” or “contour” of an object by guiding a beam along a computer-controlled path based on, for example, one or more lines (or vectors) in a Computer Aided Design (CAD) of the object. Similarly, interior portions of an object, for example, “infill,” may be created by moving a beam along a series of parallel (i.e. “hatched”) or intersecting lines (i.e. “cross-hatched”) within an outline of the object. Such lines may be referred to as “hatch vectors” or just “vectors” and may be included in data comprising a CAD design. The beam is then scanned back and forth along the hatch vectors so that underlying material is cured in a controlled manner. The hatch vectors may be offset from an object boundary by an “offset boundary,” which may dictate where a hatch vector should stop given a proximity to an object boundary and a selected beam spot width. Additionally, the scanner may manipulate a beam emitted by a radiant emitter using optical elements, such as mirrors, focusing lenses, and other optical elements, such that the focal point of the beam, or “beam spot”, on an object being formed is relatively larger or relatively smaller. Finally, the scanner may further manipulate the power or energy level of the beam using electrical control elements.

The total time needed to process a layer of an object during additive manufacturing may be impacted by the number of vectors the scanner needs to follow to form that particular layer. For example, when many hatch vectors are needed to process a single layer of an object, the total processing time is impacted not only by the time needed to actively process the base material using the beam (e.g. curing), but also by the time needed to move the scanner between various vector endpoints and vector starting points. These so-call “jumps” (i.e. movements of the scanner not intended to process the underlying material) may amount to a significant amount of time over the course of manufacturing a particular layer, and even more so when considering the time to manufacture an entire object.

Various optical additive manufacturing technologies that use radiant emitters are known in the art, such as: Stereolithography (SLA), Selective Laser Sintering (SLS) and Selective Laser Melting (SLM). In cases where a laser emitter is used in SLA, SLS, or SLM, the process may be generally referred to as Laser Additive Manufacturing (LAM).

Stereolithography (SLA) is an optical additive manufacturing technique used for “printing” three-dimensional (3D) objects one layer at a time. An SLA apparatus may employ, for example, an Ultraviolet (UV) Laser to cure a photo-reactive substance with emitted radiation. In some embodiments, the SLA apparatus directs the UV laser across a surface of a photo-reactive substance, such as, for example, an ultraviolet-curable photopolymer (“resin”), in order to build an object one layer at a time. For each layer, the laser beam traces a cross-section of the object on the surface of the liquid resin, which cures and solidifies the cross-section and joins it to the layer below. After a layer has been completed, the SLA apparatus lowers a manufacturing platform by a distance equal to the thickness of a single layer and then deposits a new surface of uncured resin (or like photo-reactive material) on the previous layer. On this surface, a new pattern is traced thereby forming a new layer. By repeating this process one layer at a time, a complete 3D part may be formed.

Stereolithography may require the use of structures that attach and support the object being formed to the manufacturing platform in order to prevent deflection due to gravity and other manufacturing steps (such as depositing new surfaces). Support structures may be generated during the creation of a Computer Aided Design (CAD) model of the object to be manufactured. Support structures are typically removed from the finished product.

Selective laser sintering (SLS) is another optical additive manufacturing technique used for 3D printing objects. SLS apparatuses often use a high-powered laser (e.g. a carbon dioxide laser) to “sinter” (i.e. fuse) small particles of plastic, metal, ceramic, or glass powders into a 3D object. Similar to SLA, the SLS apparatus may use a laser to scan cross-sections on the surface of a powder bed in accordance with a CAD design. Also similar to SLA, the SLS apparatus may lower a manufacturing platform by one layer thickness after a layer has been completed and add a new layer of material in order that a new layer can be formed. In some embodiments, an SLS apparatus may preheat the powder in order to make it easier for the laser to raise the temperature during the sintering process.

Unlike SLA, SLS does not necessarily require support structures because the object being formed may be surrounded by un-sintered powder at all times, which provides support for the object. Therefore, objects manufactured by this method may not require the step of removing support structures.

Selective Laser Melting (SLM) is yet another optical additive manufacturing technique used for 3D printing objects Like SLS, an SLM apparatus typically uses a high-powered laser to selectively melt thin layers of metal powder to form solid metal objects. While similar, SLM differs from SLS because it typically uses materials with much higher melting points. When constructing objects using SLM, thin layers of metal powder may be distributed using various coating mechanisms. Like SLA and SLS, a manufacturing surface moves up and down to allow layers to be formed individually.

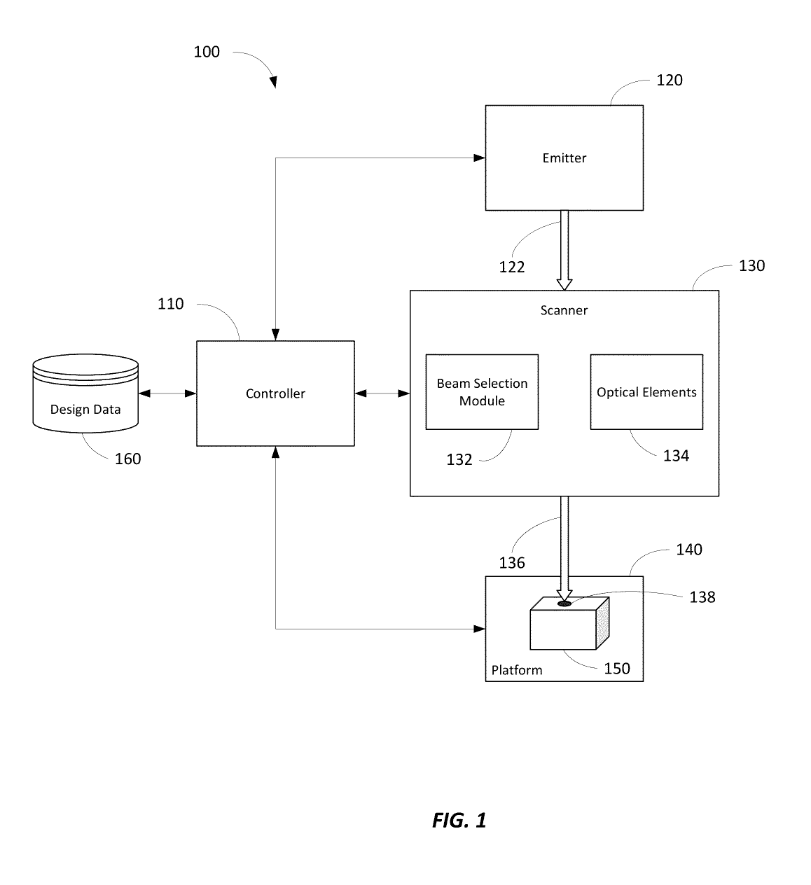

FIG. 1 depicts an optical additive manufacturing apparatus 100 that may be configured to perform optical additive manufacturing techniques such as SLA, SLS, and SLM, and others as are known in the art.

Optical additive manufacturing apparatus 100 includes a controller 110, which is in data communication with an emitter 120, a scanner 130, and a platform 140. Controller 110 may be, for example, a computer system with software for operating optical additive manufacturing apparatus 100. In other embodiments, controller 110 may be embodied as a general purpose processor, a digital signal processor (DSP), an application-specific integrated circuit (ASIC), a field-programmable gate array (FPGA) or other programmable logic device, discrete gate or transistor logic, discrete hardware components, or any suitable combination thereof designed to perform the functions described herein as are known by those of skill in the art.

Notably, the lines of data communication depicted between controller 110 and emitter 120, scanner 130, and platform 140 in FIG. 1 are representative only. The data communication path between controller 110 and aspects of optical additive manufacturing apparatus 100 may be direct or indirect, may traverse a single or multiple networks, may include intervening devices, may be wired or wireless, may use different protocols, may use different mediums, etc. Moreover, the data communication paths may be one-way or two-way such that data may be shared between various devices. For example, platform 140 may report data regarding its position back to controller for a closed-loop type control.

Controller 110 may control emitter 120. For example, controller 110 may send data signals to emitter 120 in order to power on and off the emitter. Additionally, controller 110 may control the output power of emitter 120. In some embodiments, controller 110 may control multiple emitters 120 (not shown) in the same optical additive manufacturing apparatus 100. In some embodiments, emitter 120 may additionally send data back to controller 110. For example, emitter 120 may send operational parameters such as power output, power use, temperature, and other operational parameters as are known in the art. The operational parameters of emitter 120 may be used by controller 110 to further control or optimize the processing of object 150.

Controller 110 may also control scanner 130. For example, controller 110 may cause scanner 130 to select a certain beam spot size. In some embodiments the controller may cause a beam spot size to be selected via beam selection module 132. Notably, while depicted in FIG. 1 as part of the scanner, beam selection module 132 may be a part of the controller 110 in some embodiments or completely independent in other embodiments. Also notable, when referring to “beam size”, “beam spot size”, “beam width”, “beam spot width”, etc., the typical implication is the size of the spot formed by the beam incident on a particular surface. In some cases, the beam width and the beam spot width may be the same. However, in other cases, focusing or other optical elements may cause the beam spot to become larger or smaller than the beam emitted by emitter 120.

Controller 110 may also cause the selection, manipulation, articulation, engagement or other use of optical elements 134. For example, controller 110 may cause a focusing lens element to move in order to affect the size of a resulting beam 136 or a size of a resulting beam spot 138. Further, controller 110 may cause a mirror or similar optical element to redirect resulting beam 136 in different directions and onto different locations of object 150. As yet another example, controller 110 may cause a shutter or similar optical element to mask resulting beam 136 even while emitter 120 is active.

In some embodiments, controller 110 may receive data back from scanner 130. For example, scanner 130 may send operational parameters such as power output, power use, temperature, beam size selection, beam power, beam direction, beam spot position, position of optical elements, condition of optical elements, and other operational parameters as are known in the art. The operational parameters of emitter 120 may be used by controller 110 to further control or optimize the processing of object 150. In some embodiments, controller 110 may be a part of scanner 130.

Controller 110 may also control platform 140. For example, controller 110 may cause platform 140 to move in one or more dimensions (e.g. up and down or side to side). Controller 110 may receive operational data from platform 140, such as position, temperature, weight, proximity, and others as are known to persons of skill in the art. Controller 110 may cause platform 140 to move in increments of one layer of object 150 at a time so that scanner 130 can process a layer of material to add to object 150. Layers of object 150 may be defined in three-dimensional design drawings (e.g. 3D CAD) or in one or more two dimensional cross-sectional drawings (e.g. 2D CAD).

In some embodiments, controller 110 may store or otherwise have access to object design data, such as 3D CAD drawings of an object to be manufactured by optical additive manufacturing apparatus 100. For example, controller 110 may be a part of a computer system that also includes object design software and hardware, such as CAD software. In this way, controller 110 may have access to object design data in order to control emitter 120, scanner 130, and platform 140 and to manufacture object 150. In other embodiments, controller 110 may be connected by a communication path to a repository, database, or the like of design data, such as database 160 in FIG. 1.

Emitter 120 may be, for example, a laser emitter, such as a diode laser, pulsed laser, or fiber layer, or other types of laser as are known by those of skill in the art. In some embodiments, the emitter 120 may be an ultraviolet laser, carbon dioxide laser, or ytterbium laser. Emitter 120 may be other types of irradiating emitters as known by those of skill in the art.

Emitter 120 emits a beam, for example laser beam 122, which is then processed by scanner 130. Notably, while not shown in FIG. 1, optical elements such as mirrors, lenses, prisms, filters, etc., may be located between the emitter 120 and scanner 130.

In some embodiments, emitter 120 may be a part of scanner 130.

Scanner 130 may include a beam selection module 132 and optical elements 134. Beam selection module 132 may be responsive to data commands from controller 110 to select a beam characteristic (e.g. spot width) for processing object 150. As will be discussed further below, the beam selection module may use rules, heuristics or algorithms implemented in software and hardware in order to select optimal beam characteristics for processing object 150. In some embodiments, beam selection module 132 may determine beam characteristics using data from controller 110. In other embodiments, beam selection module may additionally use data from scanner 130 when determining beam characteristics.

Scanner 130 also includes optical elements 134. For example, optical elements may include lenses, mirrors, filters, splitters, prisms, diffusers, windows, displacers, and other elements as are known in the art. The optical elements 134 may be fixed or moveable based on data received by scanner 130 or controller 110.

Scanner 130 may also include sensors (not shown) that sense various operating parameters during operation of the scanner 130. Generally speaking, the sensors may provide data feedback to the scanner 130 and or controller 110 in order to improve calibration and manufacturing performance of optical additive manufacturing apparatus 100.

For example, scanner 130 may include position sensors, heat sensors, proximity sensors, and the like. Additionally, scanner 130 may include one or more image sensors. The image sensors could be used to provide visual feedback to an operator of optical additive manufacturing apparatus 100. The image sensors could also be used, for example, to analyze the size, focus and position of the beam spot incident on the object being manufactured for calibration and precise tracking. Further, the image sensor may be sensitive to heat (e.g. a thermal image sensor) and be used to determine the state of the underlying material (e.g. resin) as it is being processed. For example, a thermal image sensor may measure the local heating around the beam spot and/or the level of curing of the material being processed.

Platform 140 acts as a moveable base for the manufacture of object 150. As described above, platform 140 may move in one or more directions and be controlled by a controller, such as controller 110. For example, platform 140 may be controlled by controller 110 and moved one layer or cross-section of object 150 at a time during the manufacture of object 150.

Platform 140 may include sensors that determine operational data and transmit that data to controller 110 or to other parts of optical additive manufacturing apparatus 100.

Platform 140 may be enclosed by a container or vessel (not shown) containing manufacturing materials (e.g. photosensitive resin) that is processed by an incident beam spot directed by scanner 130. For example, scanner 130 may direct a beam over a layer of photosensitive resin, which causes the resin to cure and form a permanent layer of object 150.

Platform 140 may be made of any suitable material of adequate strength and resilience to serve as a manufacturing base for objects like object 150.

In addition to a container or vessel around platform 140, optical additive manufacturing apparatus 100 may also include a manufacturing material dispensing element. For example, an element may dispense a new layer of manufacturing material after each respective layer of object 150 is completed by the action of scanner 130.

Object 150 is formed by optical additive manufacturing apparatus 100 using various methods, such as SLA, SLS, SLM and others as are known by those of skill in the art. Object 150 may be formed of any material suitable for optical additive manufacturing. Suitable materials include, for example: polypropylene, thermoplastic polyurethane, polyurethane, acrylonitrile butadiene styrene (ABS), polycarbonate (PC), PC-ABS, polyamide, polyamide with additives such as glass or metal particles, resorbable materials such as polymer-ceramic composites, and other similar suitable materials. In some embodiments, commercially available materials may be utilized. These materials may include: DSM Somos® series of materials 7100, 8100, 9100, 9420, 10100, 11100, 12110, 14120 and 15100 from DSM Somos; Accura Plastic, DuraForm, CastForm, Laserform and VisiJet line of materials from 3-Systems; Aluminium, CobaltChrome and Stainless Steel materials; Maranging Steel; Nickel Alloy; Titanium; the PA line of materials, PrimeCast and PrimePart materials and Alumide and CarbonMide from EOS GmbH.

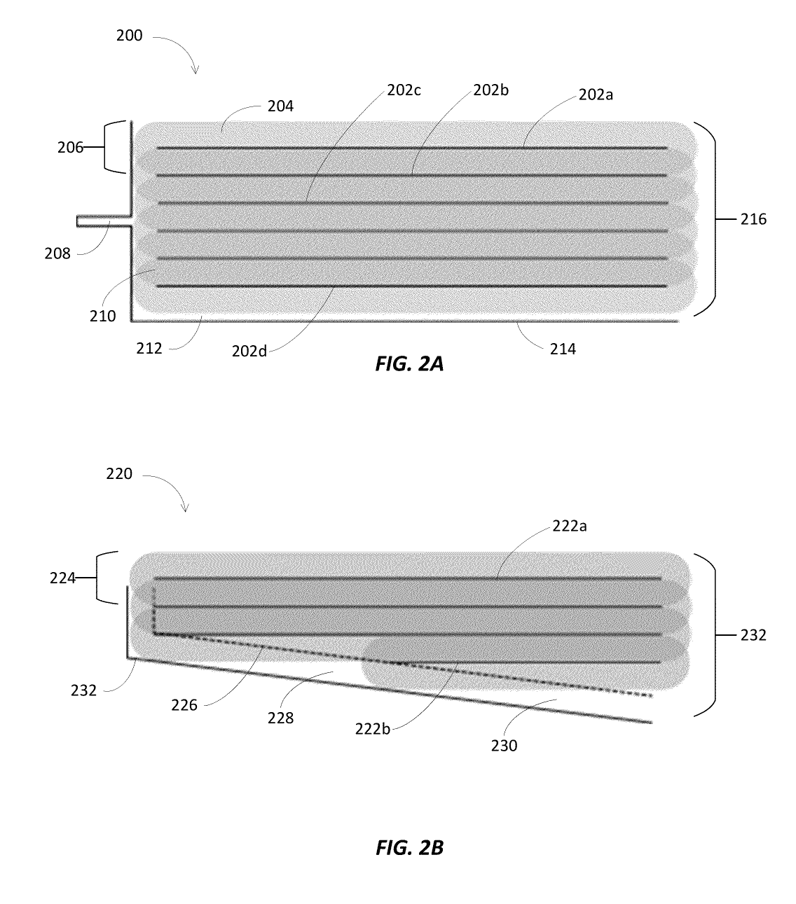

As discussed briefly above, there are advantages and disadvantages associated with selected beam characteristics, such as beam spot width, when using an apparatus such as optical additive manufacturing apparatus 100 to create an object. FIG. 2A shows an example of an object layer 200 demonstrating various problems that may arise given the selection of a particular beam characteristic, such as beam spot width. Object layer 200 includes a “hatching area” or “infill area” 216 wherein a beam spot will be directed in order to process material so as to fill in that portion of object layer 200. For example, a beam may process and harden a photosensitive resin so as to make the infill area of object layer 200 solid.

Lines 202a, 202b, 202c, and 202d in FIG. 2A are representative “beam vectors” or “hatch vectors” or simply “hatch lines”, which indicate the path of the beam spot along object layer 200. The lines parallel to hatch vectors 202a, 202b, 202c, and 202d within boundary 212 are also hatch vectors. As the beam spot incident on object layer 200 (not shown) moves along hatch vector 202a, it processes an area 204 of the object layer 200 with width of bracket 206, which is also referred to as the beam spot width. As described in more detail below, the width 206 of the beam spot may be selected using, for example, controller 110 to manipulate optical elements 134 within scanner 130. Notably, in FIG. 2A, the hatch vectors (e.g. hatch vector 202a, 202b, 202c, and 202d) are spaced at intervals of roughly half the beam spot width 206. Thus, in some embodiments the beam spot would be directed along a first hatch vector (e.g. 202a) in a first direction (such as right-to-left) and then directed along a second hatch vector (e.g. 202b) in a second direction (such as left-to-right). Notably, while the hatch vectors (e.g. 202a and 202b) are shown as parallel and evenly spaced, they need not be in every embodiment.

In the example depicted in FIG. 2A, the beam spot would be directed down each hatch vector so that substantially all of the infill area is processed (e.g. hardened) by the beam spot. In this example, a scanner would direct a beam with beam spot width 216 along all six hatch vectors (e.g. 202a, 202b, 202c, and 202d) in order to process substantially all of the infill area 216. And following the six hatch vectors in a back-and-forth arrangement would call for at least five “jumps” of the beam i.e. movements of the beam spot not intended to process the underlying material. These jumps may require, for example, movements of the scanner 130 or movements of the optical elements 134 within the scanner. Further, these jumps have a time associated with them, which is time lost during the processing of object layer 200 and more generally, the entire object.

Feature 208 of FIG. 2A depicts an exemplary problem when choosing a particular beam characteristic, such as beam spot width. As can be seen, the width of feature 208 is smaller than the width of the beam spot 206. Thus, the beam at its current width cannot process the feature of 208. However, if the beam spot width were chosen such that it could fit within the contours of feature 208, it is apparent that many more hatch vectors would be needed to process the infill area 216. Thus, there is a tradeoff between processing time and the features that can be processed based on the selection of beam spot width. For example, a larger beam spot width may reduce the processing time of an infill area because fewer hatch vectors are needed, but this benefit comes at the expense of not being able to process smaller features (e.g. feature 208 of object layer 200).

Unprocessed area 212 of FIG. 2A depicts another exemplary problem when choosing a particular beam characteristic, such as beam spot width. Notably, in this example, the hatch vectors are arranged such that the beam spot processes a path going in one direction, and then re-processes approximately half that path again when going in the opposite direction. Thus, the darker shaded areas in FIG. 2A, such as area 210, indicate areas that have been processed with more energy from the beam spot. As can be seen in FIG. 2A, the width of the beam spot is not sufficient to process all of the area between the layer boundary 214 and the area processed as a result of hatch vector 202d. While it is possible to alter the hatch vector 202d by moving it towards the layer boundary 214, this would create less processing overlap in area 210 and could lead to weak points in that area of the infill. To avoid this, a slightly larger beam spot width or radius that is cleanly divided into the infill area could be chosen. However, as with before, choosing a larger beam spot width based on the size of the infill area may result in a beam that is not optimally sized for features of a layer. Similarly, choosing a smaller beam spot width that will also cleanly divide the infill area 216 space, may result in increased processing time of the object layer 200.

FIG. 2B depicts yet another problem when choosing a particular beam characteristic, such as beam spot width. Similar to FIG. 2A, the object layer 220 in FIG. 2b includes a layer boundary 232 and hatch vectors (e.g. 222a and 222b) within an infill area 232. Additionally, FIG. 2B depicts an offset boundary 226. The offset boundary 226 indicates an area beyond which the center of the beam spot should not pass in order that the beam spot not impinge upon the layer boundary 232. As such, the offset boundary 226 is set back (or inwards) from the layer boundary by a distance of half the beam spot width (or the radius of the beam spot where the beam spot is circular in shape). Notably, other distances may be chosen, but a boundary of half the beam spot width may be preferable where as much infill as possible is meant to be processed. As is shown in FIG. 2B, hatch vectors 222a and 222b terminate at the offset boundary 226 in order to prevent the processed infill area from running over the layer boundary 232.

As with before, FIG. 2B shows the result of processing an infill area 232 using hatch vectors (e.g. 222a and 222b) and a beam spot width 224. And as with before, the hatch vectors are parallel and equally spaced within infill area 232. As can be seen in FIG. 2B, unprocessed areas 228 and 230 are the result of the parallel and equally spaced hatch vectors. Unprocessed areas 228 and 230 could lead to structural weaknesses or cosmetic defects in the object layer 220, and more generally in the overall object. Smaller hatch vectors would effectively reduce the size of unprocessed areas 228 and 230, but at the expense of having more hatch vectors, more jumps, and consequently more processing time. Additionally, non-parallel hatch vectors could eliminate unprocessed areas 228 and 230 (e.g. by having a hatch vector essentially follow offset boundary 226). However, non-parallel hatch vectors that intersect may decrease the homogeneity of curing in certain regions, particularly in areas where the vectors overlap.

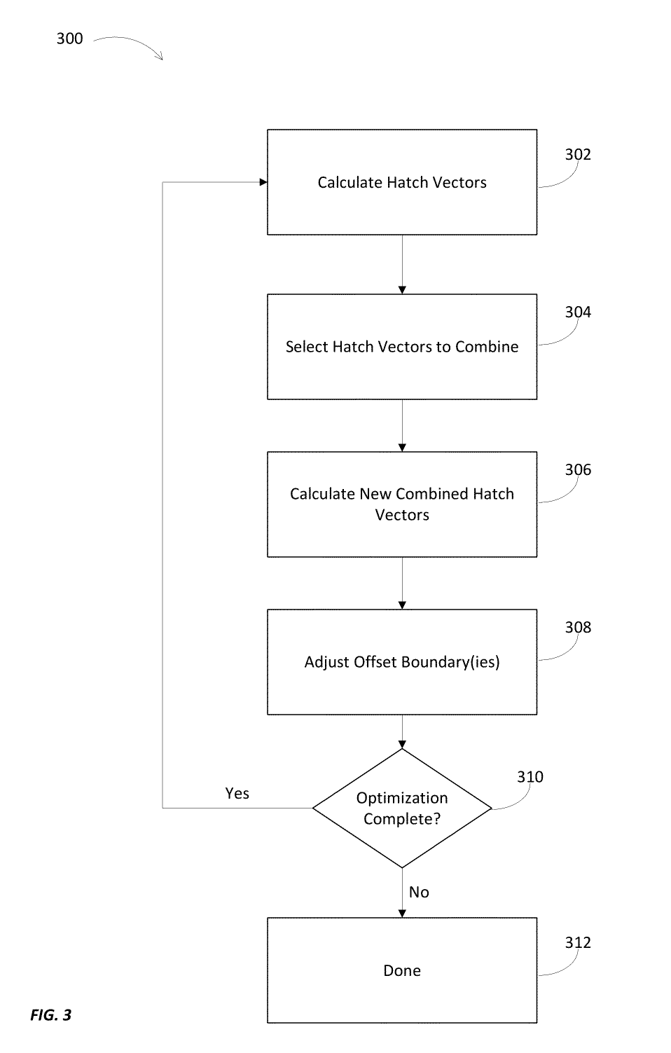

FIG. 3 depicts an exemplary method 300 for improving hatch vector calculation using multiple beam spot sizes. The method 300 begins at step 302, where hatch vectors for a particular infill area are calculated. As described above, the hatch vectors may be determined such that they begin at least half the beam spot width away from a particular object layer boundary, or such that they stop at an offset boundary. As described above, this is in order that the beam spot does not impinge upon the layer boundary during processing. If the hatch vectors are to be calculated such that the beam spot processes certain infill areas more than once (e.g. overlap area 210 in FIG. 2A), then the hatch vectors may be determined at half-beam spot width intervals throughout the infill area.

In other embodiments, the hatch vectors may be calculated in step 302 using different schemes. For example, in some embodiments the hatch vectors are calculated such that they are all parallel to each other while in other embodiments the hatch vectors may overlap each other at selected angles. For example, cross-hatched vectors may intersect at orthogonal angles or other angles as necessary. Moreover, hatch vectors at different angles may be processed using a scanner with the ability to direct the beam in multiple dimensions (e.g. x and y) or with a platform that can rotate with respect to the scanner, or both.

Once the hatch vectors have been calculated in step 302, the method 300 progresses to step 304, where certain hatch vectors are selected to be combined. The selection of hatch vectors to be combined may be done in many ways. In one embodiment, all hatch vectors of a particular beam spot size are pairwise compared to determine whether each particular pair of hatch vectors is a candidate to be combined based on certain, predetermined combination parameters.

For example, a first combination parameter may be the distance between one or more endpoints of each hatch vector being pairwise compared. In certain embodiments, it is preferable to combine hatch vectors where their endpoints are relatively close in order that the resulting combined hatch vector may be roughly the same length and distance from the object layer boundaries near the endpoints of the hatch vectors. This is because where the endpoints of two hatch vectors are not close, a combined hatch vector may result in unprocessed infill area or the need to create additional hatch vectors to process the uncombined spaces—both of which may negatively impact processing speed or efficiency.

In some embodiments, multiple combination parameters may be considered during step 304. For example, in addition to comparing the distance between one or more endpoints of each hatch vector being compared, the length of each hatch vector or the resulting length of a combined hatch vector may be considered. If, for example, the length of the hatch vectors being compared is relatively longer and the endpoints are relatively close together, then combining the hatch vectors may increase the efficiency of processing an infill area with a larger beam spot size. If, however, the length of the hatch vectors are relatively short, then the resulting larger hatch vector may offer little if any process efficiency.

Other combination parameters may be used. Examples of combination parameters include aspects related to the absolute or relative position of a hatch vector, the size of a hatch vector (e.g. length), the angle of a hatch vector, the total number of hatch vectors, the resulting size of a combined hatch vector, and others as are known in the art.

In some embodiments, multiple combination parameters may be considered, while in other embodiments only a single combination parameter may be considered. In yet other embodiments, multiple combination parameters may be considered and given different weight in order to reach a determination as to whether the hatch vectors being considered should be combined. For example, a variety of combination vectors with different weights could result in an overall combination score that is then compared to a combination score threshold to determine whether to combine the hatch vectors being compared.

In some embodiments, only parallel hatch vectors are compared during any particular instance of step 304. However, as method 300 is depicted as a loop, it is possible that groups of parallel hatch vectors that are parallel within the group, but not parallel to other groups (such as cross-hatch vectors), may be compared independently. That is, the step of selecting hatch vectors to combine can be done in discrete steps considering discrete groups of vectors (such as parallel vectors), or it may be done all at once.

Method 300 then moves to step 306, where new, combined hatch vectors are calculated. In some embodiments, the beam spot size for the new, combined hatch vectors will be increased (e.g. doubled) and the combined hatch vector will be calculated down the midpoint between the two hatch vectors selected to be combined in step 304. For example, were hatch vectors 202a and 202c in FIG. 2A selected to be combined, the combined hatch vector may be drawn down line 202b, which is at the midpoint of hatch vectors 202a and 202c. That combined hatch vector may have a beam spot width double that of beam spot width 206. And, as a result, the area processed by hatch vectors 202a and 202c, which would require multiple passes of a scanner, could instead be processed with half as many passes given the doubled beam spot size. In other embodiments, the beam spot size of the combined hatch vector may instead be set to other multiples or fractions of the beam spot widths of the hatch vectors selected to be combined.

After the new hatch vectors based on the hatch vectors selected to be combined have been calculated in step 306, the method 300 moves to step 308, where an offset boundary (or boundaries) is adjusted. As described above, if a new hatch vector is created with a larger beam spot size, then the offset from the object boundary on either side of the hatch vector needs to be adjusted so that the larger beam spot size does not impinge on the object boundary. In some embodiments, the offset boundary on each side of the combined hatch vector is set to the half the width or the radius of the combined hatch vector.

After an offset boundary is adjusted in step 308, the method 300 moves to step 310, where it is determined whether the optimization is complete i.e. whether the method should continue. In some embodiments, the determination of whether the method 300 should continue is based on a beam spot size used for calculating the combined hatch vectors reaching a maximum beam spot size. Such a parameter may be set arbitrarily, or may be an inherent limitation of the system design, the emitter, the optical elements, or the like as is known by those of skill in the art. In other embodiments, the determination may be based on reaching a certain predefined number of iterations, or a number of combined vectors, or a number of resulting vectors, or a resulting vector size, or the like. If it is determined that the method should continue, then the method returns to step 302. If, however, it is determined that the method should not continue, then the method completes at step 312.

Notably, method 300 is only one embodiment of a method for determining the beam spot size of hatch vectors for a particular infill area. The depicted and described steps may not all be necessary, and other steps may be added as determined by those of skill in the art. Additionally, the method 300 described in FIG. 3 may be implemented, for example, by a hardware and/or software module such as beam selection module 132 in FIG. 1.

An example of a programmable algorithm for implementing a process similar to that depicted in FIG. 3 follows:

Exemplary Algorithm

Set BeamSize = minBeamSize;
While BeamSize <= ( maxBeamSize / 2 ) {

BeamSize = ( BeamSize * 2 );
For All Vectors i With BeamSize = ( BeamSize / 2 ) {

If (Vector(i)EndPoint − Vector(i+1)EndPoint <
EndPointThreshold) &&
(Vector(i)Length && Vector (i+1)Length >
VectorLengthThreshold)

NewVector = RecalculateVector (Vector(i),
Vector(i+1));
RecalculateOffset(NewVector);
i = i + 2;

Else

i = i + 1;

}

}

The above algorithm is an example of an algorithm that may be used to optimize existing hatch vectors for a particular object layer. For example, the above algorithm could be programmed into computer-executable code and executed by a processing device. In the above algorithm, “BeamSize”, “minBeamSize”, and “maxBeamSize” are all programmable variables.

The algorithm begins by setting “BeamSize” as a minimum hatch beam size, “minBeamSize.” Notably, here it is assumed that the hatch beam size is the same as the beam spot size. The minimum hatch beam size may be, for example, between 0.05 mm and 0.6 mm. In other embodiments, the initial hatch beam size may be different sizes based on the emitter type, material to be processed, scanner, optical elements, and other parameters as are known by those of skill in the art. In some embodiments, the initial hatch beam size will be determined to be a size that is equally divisible into a particular dimension of a particular infill area (e.g. the height, width, or other arbitrary direction of the area). Similarly, the initial hatch beam size may be determined to have a radius that is equally divisible into a particular dimension of a particular infill area.

The algorithm then enters a “while loop” that runs while the variable “BeamSize” is less than or equal to half the “maxBeamSize.” The first step in the while loop is to increment the “BeamSize” variable by a factor of two. Notably, in other embodiments, the value that “BeamSize” is incremented may be different.

The algorithm then enters a “for loop” within the while loop. The for loop iterates through all of the hatch vectors with a particular BeamSize and makes decisions on whether or not to combine hatch vectors based on predetermined conditions (e.g. logical tests or functions).

In this embodiment, the for loop first compares a first pair of hatch vector endpoints using the function “Vector(i)Endpoint” to determine whether the distance between them is less than a threshold, “EndPointThreshold.” Notably, in this example, only one endpoint is considered in one dimension in the interest of brevity. However, in other embodiments, multiple endpoints may be evaluated in multiple dimensions.

The for loop next compares each hatch vectors length to a threshold, “VectorLengthTheshold” using the function “Vector(i)Length.”

If, based on the “EndPointThreshold” and “VectorLengthThreshold” determinations, all of the logical tests returns a “true” value, then the function “RecalculateVector” recalculates a new, combined hatch vector “NewVector” based on the two hatch vectors presently being compared (i.e. Vector(i) and Vector(i+1)). Additionally, because the new, combined hatch vector will have a new beam size, the offset value for the object layer boundary needs to be changed for that vector. Recall that in some embodiments, the offset is approximately equal to half the beam spot width (which is the same as the beam radius for a round beam). Thus, the function “RecalculateOffsetQ” calculates a new offset for “NewVector.”

If, on the other hand, one of the logical comparisons returns a “false,” then the hatch vector pointer ‘i’ is incremented to the next hatch vector and the for loop repeats. And if there are no more hatch vectors with BeamSize=(BeamSize/2), then the for loop exits to the while loop, where the BeamSize is incremented by a factor of two again. The algorithm thus repeats until it finishes with all of the hatch vectors.

As can be seen with the algorithm above, combined hatch vectors may be further reconsidered and combined as the algorithm iterates through a variety of hatch beam sizes. This iterative approach may result in two or more hatch vector sizes for a particular infill area. For example, an instance of the algorithm might consider “BeamSizes” including 0.05, 0.1, 0.2, 0.4, and 0.8 mm before terminating.

Notably, the algorithm, above, is only one embodiment of an algorithm for determining the beam spot size of hatch vectors for a particular infill area. The described steps may not all be necessary, and other steps may be added as determined by those of skill in the art. The algorithm, above, may be implemented, for example, by a hardware and/or software module such as beam selection module 132 in FIG. 1.

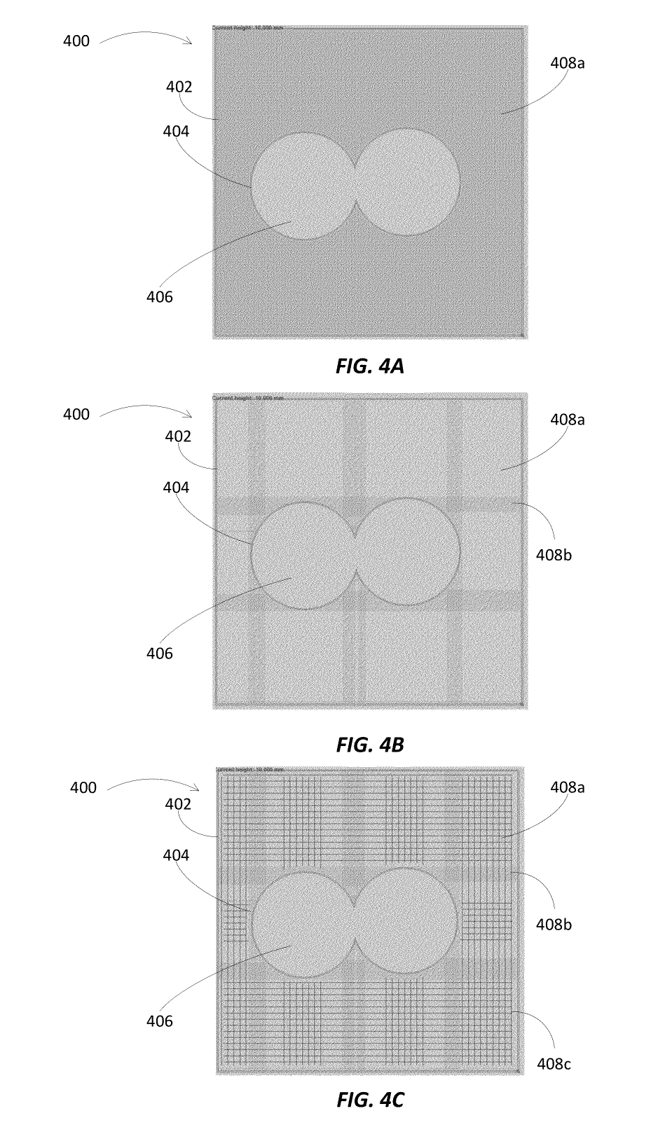

FIGS. 4A-4C show an example of the results of hatch vector optimization. Starting with FIG. 4A, it can be seen that an object layer 400 includes an infill area with cross-hatched vectors 408a of a certain, uniform beam spot width. Object layer 400 also includes an external object layer boundary 402 as well as an internal object layer boundary 404. The internal object layer boundary 404 forms a void 406 where there will be no processed infill material.

FIG. 4B depicts the same object layer 400 after an iteration of a hatch vector optimization, such as those discussed above with respect to FIG. 3 and the algorithm. Notably, object layer 400 now includes two areas (408a and 408b) with different cross-hatch vectors based on different beam spot sizes. As can be seen, due to the large areas of object layer 400 that have no small or otherwise troublesome features, it is easy to combine many vectors so as to be able to use larger beam spot sizes when processing the infill area. And as discussed earlier, large beam spot sizes may reduce the number of hatch vectors and jumps between the hatch vectors necessary, which in-turn may reduce the amount of time to needed to process all of the hatch vectors in the infill area.

FIG. 4C depicts the same object layer 400 after an additional iteration of a hatch vector optimization. Now, object layer 400 includes three areas (408a, 408b, and 408c) with different cross-hatch vectors based on different beam spot sizes. As can be seen, here again, the large areas of object layer 400 without problematic features may be processed with larger beam spot sizes and fewer hatch vectors. Also notable in FIG. 4C is the fact that the larger beam spot hatch vectors, such as those in 408c, do not come as near to the external or internal object layer boundaries (402 and 404, respectively) as the hatch vectors with much smaller beam spot sizes. This is because the offsets of those vectors has been adjusted to compensate for the larger beam spot sizes.

While FIGS. 4A-4C only depict three iterations of the hatch vector optimization process, in other embodiments there may be fewer or more iterations needed to fully optimize the use of multiple beam spots to improve process efficiency. In part, the number of iterations may depend on things like parameters of the optimization scheme and the shape and features of the particular object layer.

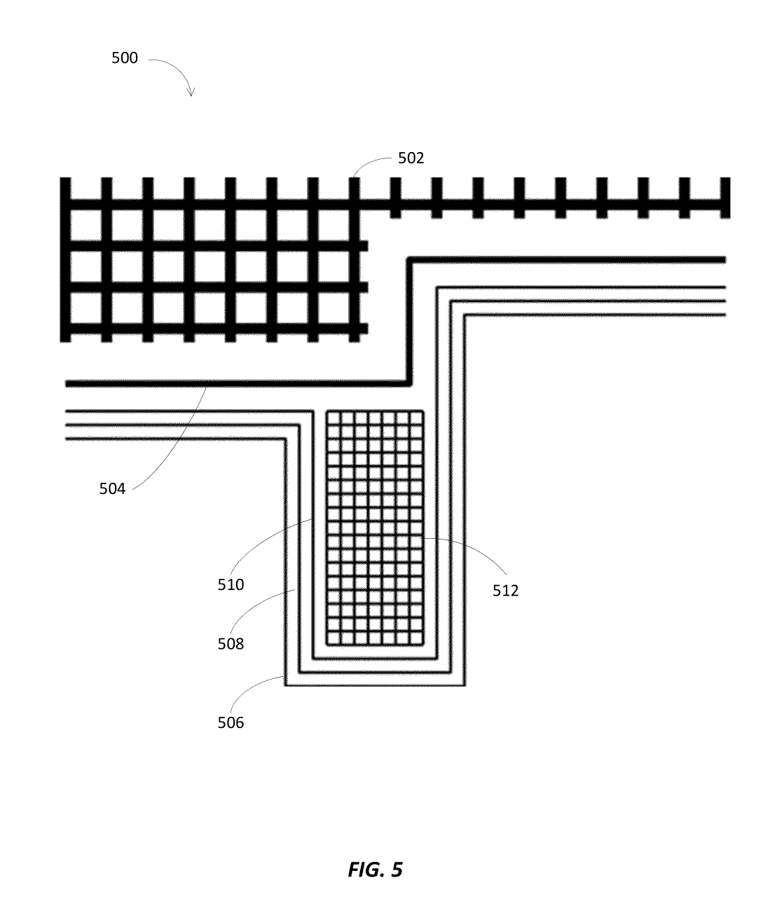

FIG. 5 depicts another possible method for optimizing hatch vectors in an object layer 500. Hatch vectors 502 have a particular beam spot size, which requires an offset boundary 504. Unlike the examples depicted in FIGS. 4A-4C, though, here the infill is divided into a plurality of discrete infill sub-areas that each have their own beam spot sizes.

For example, FIG. 5 depicts two fully encapsulated areas with hatch vectors based on different beam spot sizes. Specially, hatch vectors 502 correspond to a larger infill area with no small features so that a larger beam spot may be used, thereby cutting down processing time of that particular infill area. Hatch vectors 512, on the other hand, correspond to a different, smaller beam spot size. In addition, the object layer 500 includes an object layer boundary 506 as well as two offset boundaries 508 and 510. The various offset boundaries may be used to ensure that the beam spot does not impinge on object layer boundary 506.

Thus, FIG. 5 shows a method of encapsulating hatch vectors of like sizes in certain sub-areas of an object layer so that the sub-areas can be processed with a single beam spot size at a time without the need to switch back and forth between beam sizes. This method may increase the homogeneity of curing in certain regions compared to other methods where the same area is subject to processing with different beam spot sizes at different times.

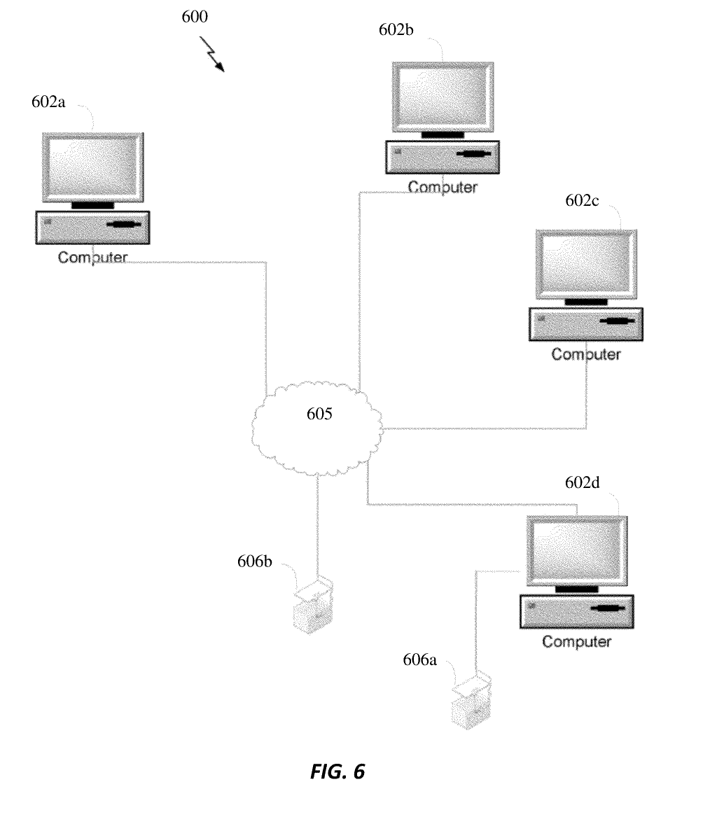

FIG. 6 illustrates one example of a system 600 for designing and manufacturing object by additive manufacturing, including, for example, by optical additive manufacturing. The system 600 may be configured to support the techniques described herein.

In some embodiments, the system 600 may include one or more computers 602a-602d. The computers 602a-602d may take various forms such as, for example, any workstation, server, or other computing device capable of processing information. The computers 602a-602d may be connected by a computer network 605. The computer network 605 may be, for example, the Internet, a local area network, a wide area network, or some other type of network capable of digital communications between electronic devices. Additionally, the computers 602a-602d may communicate over the computer network 605 via any suitable communications technology or protocol. For example, the computers 602a-602d may share data by transmitting and receiving information such as software, digital representations of 3D objections, commands and/or instructions to operate an additive manufacturing device, and the like.

The system 600 further may include one or more additive manufacturing devices 606a and 606b. These additive manufacturing devices may comprise 3D printers or some other manufacturing device as known in the art. In the example shown in FIG. 6, the additive manufacturing device 606a is directly connected to the computer 602d. The additive manufacturing device 606a is also connected to computers 602a-602c via the network 605, which further connects computers 602a-602d. Additive manufacturing device 606b is also connected to the computers 602a-602d via the network 605. A skilled artisan will readily appreciate that an additive manufacturing device such as devices 606a and 606b may be directly connected to a computer, connected to a computer, and/or connected to a computer via another computer.

Although a specific computer and network configuration is described in FIG. 6, a skilled artisan will also appreciate that the additive manufacturing techniques described herein may be implemented using a single computer configuration which controls and/or assists the additive manufacturing device 606, without the need for a computer network.

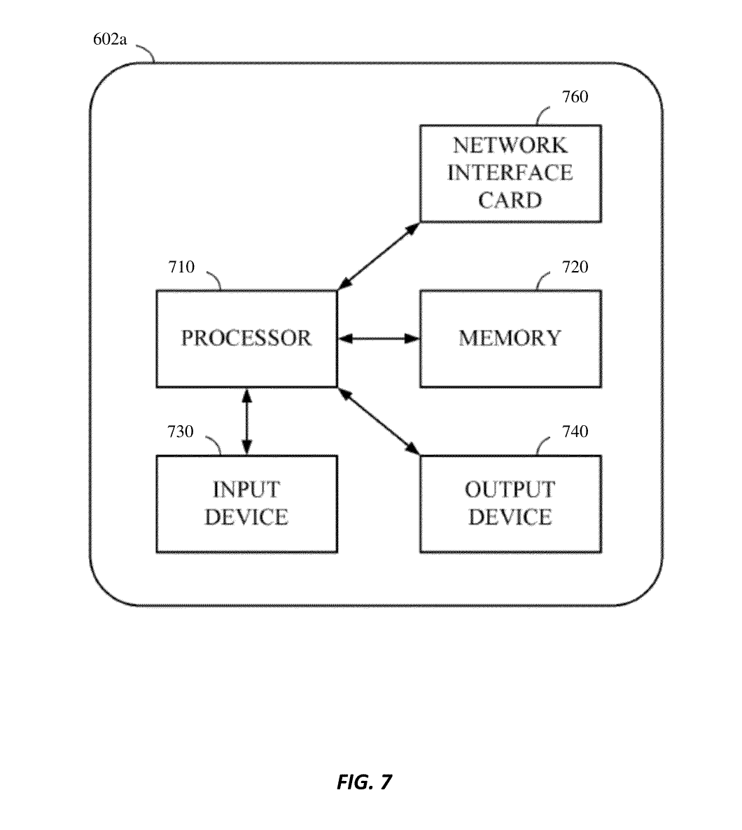

FIG. 7 illustrates a more detailed view of computer 602a illustrated in FIG. 6. The computer 602a includes a processor 710. The processor 710 is in data communication with various computer components. These components may include a memory 720, an input device 730, and an output device 740. In certain embodiments, the processor may also communicate with a network interface card 760. Although described separately, it is to be appreciated that functional blocks described with respect to the computer 602a need not be separate structural elements. For example, the processor 710 and network interface card 760 may be embodied in a single chip or board.

The processor 710 may be a general purpose processor, a digital signal processor (DSP), an application specific integrated circuit (ASIC), a field programmable gate array (FPGA) or other programmable logic device, a discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 710 may be coupled, via one or more data buses, to read information from or write information to memory 720. The processor may additionally, or in the alternative, contain memory, such as processor registers. The memory 720 may include processor cache, including a multi-level hierarchical cache in which different levels have different capacities and access speeds. The memory 720 may further include random access memory (RAM), other volatile storage devices, or non-volatile storage devices. The storage can include hard drives, optical discs, such as compact discs (CDs) or digital video discs (DVDs), flash memory, floppy discs, magnetic tape, Zip drives, USB drives, and others as are known in the art.

The processor 710 may also be coupled to an input device 730 and an output device 740 for, respectively, receiving input from and providing output to a user of the computer 602a. Suitable input devices include, but are not limited to, a keyboard, a rollerball, buttons, keys, switches, a pointing device, a mouse, a joystick, a remote control, an infrared detector, a voice recognition system, a bar code reader, a scanner, a video camera (possibly coupled with video processing software to, e.g., detect hand gestures or facial gestures), a motion detector, a microphone (possibly coupled to audio processing software to, e.g., detect voice commands), or other device capable of transmitting information from a user to a computer. The input device may also take the form of a touch-screen associated with the display, in which case a user responds to prompts on the display by touching the screen. The user may enter textual information through the input device such as the keyboard or the touch-screen. Suitable output devices include, but are not limited to, visual output devices, including displays and printers, audio output devices, including speakers, headphones, earphones, and alarms, additive manufacturing devices, and haptic output devices.

The processor 710 further may be coupled to a network interface card 760. The network interface card 760 prepares data generated by the processor 710 for transmission via a network according to one or more data transmission protocols. The network interface card 760 may also be configured to decode data received via the network. In some embodiments, the network interface card 760 may include a transmitter, receiver, or both. Depending on the specific embodiment, the transmitter and receiver can be a single integrated component, or they may be two separate components. The network interface card 760, may be embodied as a general purpose processor, a DSP, an ASIC, a FPGA, or other programmable logic device, discrete gate or transistor logic, discrete hardware components, or any suitable combination thereof designed to perform the functions described herein.

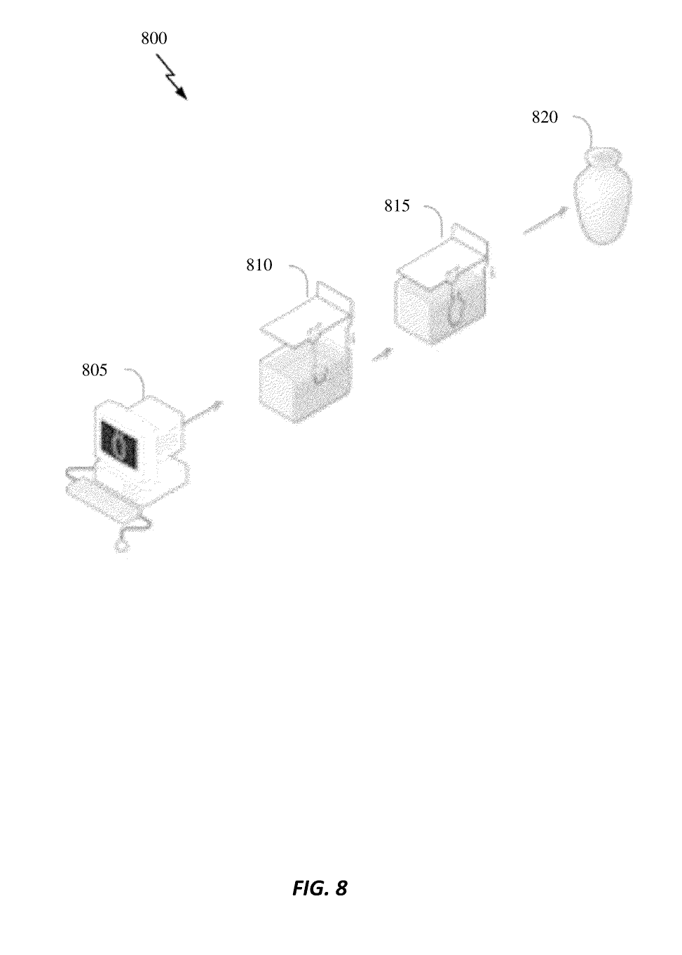

FIG. 8 illustrates a general process 800 for manufacturing an object using an additive manufacturing apparatus, such as 606a or 606b in FIG. 6.

The process begins at step 805, where a digital representation of the device to be manufactured is designed using a computer, such as the computer 602a in FIG. 6. In some embodiments, a 2D representation of the device may be used to create a 3D model of the device. Alternatively, 3D data may be input to the computer 602a for aiding in designing the digital representation of the 3D device. The process continues to step 810, where information is sent from the computer 602a to an additive manufacturing device, such as additive manufacturing devices 606a and 606b. Next, at step 815, the additive manufacturing device begins manufacturing the 3-D device by performing an additive manufacturing process using suitable materials, as described above. Using the appropriate materials, the additive manufacturing device then completes the process at step 820, where the 3D object is completed.

Various specific additive manufacturing techniques may be used to produce objects using a method like that shown in FIG. 8. As explained above, these techniques include SLA, SLS, and SLM, among others.

The invention disclosed herein may be implemented as a method, apparatus, or article of manufacture using standard programming or engineering techniques to produce software, firmware, hardware, or any combination thereof. The term “article of manufacture” as used herein refers to code or logic implemented in hardware or non-transitory computer readable media such as optical storage devices, and volatile or non-volatile memory devices or transitory computer readable media such as signals, carrier waves, etc. Such hardware may include, but is not limited to, FPGAs, ASICs, complex programmable logic devices (CPLDs), programmable logic arrays (PLAs), microprocessors, or other similar processing devices.

It will be appreciated by persons skilled in the art that numerous variations and/or modifications may be made to the invention without departing from the spirit or the scope of the invention as broadly described. The above described embodiments are, therefore, to be considered in all respects as illustrative and not restrictive.

What is claimed is:

1. An optical additive manufacturing apparatus for manufacturing an object, comprising:
a scanner configured to direct a beam emitted by an emitter towards an object layer;
a control module in data communication with the scanner, wherein the control module is configured to:
calculate a plurality of hatch vectors;
select two or more of the plurality hatch vectors to be compared;
compare the two or more selected hatch vectors to a first combination parameter; and
calculate a first new hatch vector based on the two or more selected hatch vectors.

2. The optical additive manufacturing apparatus of claim 1, wherein the emitter is a laser emitter and the beam is a laser beam.

3. The optical additive manufacturing apparatus of claim 1, wherein the first combination parameter relates to a proximity of a first endpoint of a first selected hatch vector and a first endpoint of a second selected hatch vector.

4. The optical additive manufacturing apparatus of claim 1, wherein the first combination parameter relates to a length of a first selected hatch vector.

5. The optical additive manufacturing apparatus of claim 1, wherein the control module is further configured to: compare the two or more elected hatch vectors to a second combination parameter.

6. The optical additive manufacturing apparatus of claim 5, wherein the second combination parameter is different than the first combination parameter.

7. The optical additive manufacturing apparatus of claim 1, wherein the control module is further configured to: calculate the first new hatch vector based on a first beam size.

8. The optical additive manufacturing apparatus of claim 7, wherein the control module is further configured to: calculate a second new hatch vector based on a second beam size.

9. The optical additive manufacturing apparatus of claim 1, wherein the control module is further configured to: calculate an adjusted object layer offset based on the calculated first new hatch vector.

10. The optical additive manufacturing apparatus of claim 1, wherein the scanner further comprises: a sensor.

11. A method of determining a plurality of hatch vectors, the method comprising:
calculating a plurality of hatch vectors;
selecting two or more of the plurality hatch vectors to be compared;
comparing the two or more selected hatch vectors to a first combination parameter;
calculating a first new hatch vector based on the two or more selected hatch vectors; and
directing, using a scanner, a beam emitted by an emitter along the new hatch vector.

12. The method of claim 10, wherein the emitter is a laser emitter and the beam is a laser beam.

13. The method of claim 10, wherein the first combination parameter relates to a proximity of a first endpoint of a first selected hatch vector and a first endpoint of a second selected hatch vector.

14. The method of claim 10, wherein the first combination parameter relates to a length of a first selected hatch vector.

15. The method of claim 10, further comprising: comparing the two or more elected hatch vectors to a second combination parameter.

16. The method of claim 15, wherein the second combination parameter is different than the first combination parameter.

17. The method of claim 10, wherein the control module is further configured to: calculate the first new hatch vector based on a first beam size.

18. The method of claim 17, further comprising: calculating a second new hatch vector based on a second beam size.

19. The method of claim 10, further comprising: calculating an adjusted object layer offset based on the calculated first new hatch vector.

20. The method of claim 10, wherein the scanner comprises a sensor.
